(19) United States
(12) Patent Application Publication
(10) Pub. No.: US 2009/0107744 A1
(43) Pub. Date: Apr. 30, 2009

(54) HYBRID DRIVE

(76) Inventors: Heino Foersterling, Lohr (DE); Alexander Mark, Wuerzburg (DE); Alfred Feuser, Lohr Am Main (DE); Rudolf Schaeffer, Marktheidenfeld (DE); Joerg Dantlgraber, Lohr (DE); Richard Bauer, Muenchen (DE)

Correspondence Address: Striker, Striker & Stenby, 103 East Neck Road, Huntington, NY, 11743, US

(21) Appl. No.: 12/212,268

(22) Filed: Sep. 17, 2008

(30) Foreign Application Priority Data
Sep. 18, 2007 (DE) 102007044491.7

(51) Int. Cl. B60K 6/44; B60W 10/10; B60W 20/00

(52) U.S. Cl. 180/65.225; 180/65.6; 180/65.235; 903/951

(57) ABSTRACT

A hybrid drive is disclosed, having at least two primary assemblies and a hydraulic or electric machine; one primary assembly and the hydraulic or electric machine are operatively connected to a drive train, and the hydraulic or electric machine, with this primary assembly, forms a parallel hybrid drive, and with the other primary assembly, it forms a serial hybrid drive.

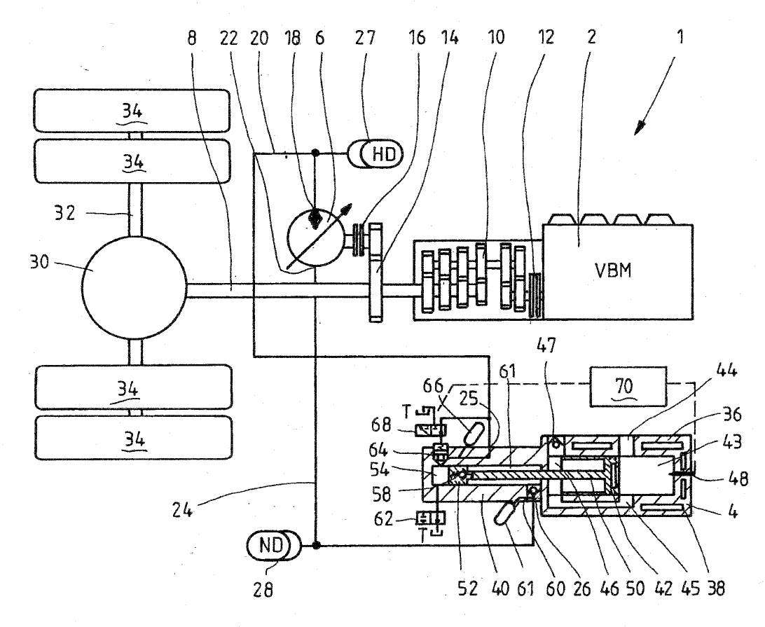

### CROSS-REFERENCE TO A RELATED APPLICATION

The invention described and claimed hereinbelow is also described in German Patent Application DE 10 2007 044 491.7 filed on Sep. 18, 2007. This German Patent Application, whose subject matter is incorporated here by reference, provides the basis for a claim of priority of invention under 35 U.S.C. 119(a)-(d).

### BACKGROUND OF THE INVENTION

The present invention relates to a hybrid drive.

A combination of various drive principles or various energy sources for driving in a particular application, such as a vehicle, is called a hybrid drive.

Depending on the arrangement and on the mechanical connection among the driving machines, a distinction is made between a serial hybrid drive and a parallel hybrid drive. In a serial hybrid drive, all the power of the internal combustion engine is converted into electrical/hydraulic energy via an electric generator or a hydraulic pump, and the drive of the vehicle is accomplished solely by means of an electric or hydraulic motor. A disadvantage of this is that the mechanical power first has to be converted into electrical/hydraulic power and then has to be converted again into mechanical power, so that the serial hydraulic motor has poor efficiency in its upper power range, such as full load.

In a parallel hybrid drive, two driving machines, such as an electric motor or hydraulic motor and an internal combustion engine, are connected to an axle drive, so that the applicable vehicle, given a suitable embodiment and location of the drive train, can be driven separately from the electric motor or hydraulic motor, separately from the internal combustion engine, or jointly by both driving machines. This embodiment has the disadvantage that the electric motor or hydraulic motor is dependent on the energy of the internal combustion engine, and driving purely by an electric motor is possible for instance only if the energy is generated by the internal combustion engine. It is true that braking energy of the vehicle can be utilized for charging the battery for the electric motor, but the battery capacity is not adequate for relatively long-term operation of a vehicle.

In U.S. Pat. No. 5,495,912, a parallel hybrid drive is disclosed in which an internal combustion engine transmits energy to a drive shaft, to which a hydraulic unit is connected that can be operated as a hydraulic pump or hydraulic motor and that drives a drive unit (gears, wheels, etc.) of a vehicle. A hydraulic reservoir is operatively connected to the hydraulic unit and can either output energy to the hydraulic motor or draw energy from the hydraulic pump. For filling the hydraulic reservoir, either the braking energy of the vehicle and thus indirectly of the engine is used, which has to furnish some of the acceleration energy before the braking event, or else the engine is used directly for driving the hydraulic pump. In addition to the engine, a further internal combustion engine can be connected to the drive shaft as well to increase the power of the parallel hybrid drive. The disadvantages of the embodiment in U.S. Pat. No. 5,495,912 are those described above, and accordingly the electric motor cannot be operated independently of the internal combustion engine that is connected to the drive shaft.

### SUMMARY OF THE INVENTION

The object of the present invention is to create a hybrid drive that can be employed quite variably and has high efficiency.

This object is attained by a hybrid drive which has two primary assemblies and a hydraulic or electric machine; one of the primary assemblies and the hydraulic or electric machine are operatively connected to a drive shaft, and the hydraulic or electric machine, with one of the primary assemblies, forms a serial hybrid drive and with the other primary assembly forms a parallel hybrid drive. The combination of a serial hybrid drive with a parallel hybrid drive offers the advantage that the hydraulic or electric machine can be operated largely independently of the primary assembly that is operatively connected to the drive shaft. For instance if that primary assembly is switched off, the hydraulic or electric machine can continue to be operated to the full scope of its function, since it is supplied with energy by the other primary assembly.

Preferably, the primary assemblies have a different size relative to their power and installation space, and as a result the hybrid drive can be adapted flexibly to the desired operating and power range of a vehicle.

Preferably, a large, relative to the installation space and to the power, primary assembly, which is operatively connected to the drive shaft, is an internal combustion engine. This engine can make a high drive power available and can move a vehicle with high efficiency at high speeds or high acceleration.

In a preferred embodiment, the smaller primary assembly, which with the hydraulic or electric machine forms a serial hybrid drive, is a free-piston engine. This free-piston engine functions quite efficiently in the low-power range and can supply the hydraulic or electric machine with sufficient energy that for instance in stop-and-go traffic, for instance, the machine can be operated largely independently of the other primary assembly (the internal combustion engine).

The free-piston engine is connected for instance on the low-pressure side to a low-pressure reservoir via a low-pressure line and on the high-pressure side to a high-pressure reservoir via a high-pressure line. Preferably, the hydraulic machine is connected to the high-pressure and low-pressure line and as a hydraulic pump can pump pressure fluid from the low-pressure reservoir to the high-pressure reservoir and as a hydraulic motor can be supplied with pressure fluid from the high-pressure reservoir and dispense it to the low-pressure reservoir.

The hydraulic machine is advantageously connected to the drive shaft via a clutch and a mechanical speed-changing transmission. As a result, the latter can be connected to the vehicle drive or disconnected from it by engagement or disengagement of the clutch.

The internal combustion engine is operatively connected to the drive shaft via a clutch and a transmission and can thus, like the free-piston engine, be connected to or disconnected from the drive.

The drive shaft is operatively connected for instance to a differential gear and to a wheel drive located on it.

The drive shaft can be driven either by the internal combustion engine or by the hydraulic motor, or by both. This makes flexible adaptation of the power of the vehicle drive to various usage conditions possible.

The hydraulic pump can advantageous be driven by the wheel drive via the differential gear and the drive shaft, which makes it possible to convert braking energy into hydraulic energy.

Other advantageous features of the invention are the subject of further dependent claims.

A preferred exemplary embodiment of the invention will be described in further detail below in conjunction with a single drawing.

### BRIEF DESCRIPTION OF THE DRAWINGS

The sole drawing FIGURE is a schematic illustration of a hybrid drive in one exemplary embodiment of the present invention.

### DESCRIPTION OF THE PREFERRED EMBODIMENTS

The drawing, in a schematic view, shows the arrangement of a hybrid drive 1, with two primary assemblies 2, 4 that have different power levels and installation space, and a hydraulic machine 6. The hydraulic machine and the primary assembly 2, which is embodied as an internal combustion engine 2 (hereinafter abbreviated as ICE 2), for instance as a diesel or gasoline engine, are operatively connected to a drive shaft 8. The ICE 2 is connected to the drive shaft 8 via a transmission 10 and a clutch 12 and is connected to the drive shaft 8 and disconnected from it via the clutch 12. The transmission 10 is embodied with a plurality of gear ratios between the ICE 2 and the drive shaft 8.

The hydraulic machine is likewise connected to the drive shaft by a transmission 14, but one with a fixed gear ratio, and a clutch 16 and can be connected to the drive shaft and disconnected from it by the clutch 16. The hydraulic machine 6 is connected via a high-pressure connection 18 to a high-pressure line 20 and via a low-pressure connection 22 to a low-pressure line 24. The high-pressure and low-pressure lines 20, 24 are in turn connected to the other primary assembly 4, which is embodied in the form of a free-piston engine 4 (hereinafter abbreviated as free-piston engine 4). The high-pressure line 20 is connected to an outlet connection 25 and the low-pressure line 24 is connected to an inlet connection 26 of the free-piston engine 4.

A high-pressure reservoir 27 is connected to the high-pressure line 20 and is thus operatively engaged with the hydraulic machine 6 and the free-piston engine 4. On the low-pressure side, a low-pressure reservoir 28 is connected to the low-pressure line 24 and is connected to the hydraulic machine 6 and to the free-piston engine 4. The hydraulic machine 6 together with the free-piston engine 4 forms a serial hybrid drive and together with the ICE 2 forms a parallel hybrid drive. The drive shaft 8 is connected to a differential gear 30, to which a wheel drive shaft 32 is connected that is connected in turn to wheels 34 of a vehicle, not shown.

The construction of the free-piston engine 4 will now be described in further detail. It has a motor housing 36, by which a combustion cylinder 38 and a hydraulic cylinder 40 are defined. A motor piston 42 is guided in a cylinder bore of the combustion cylinder 38, and by way of this piston the cylinder bore is subdivided into a combustion chamber 43 and an inlet chamber 46. The combustion chamber 43 has an outlet conduit 44 and an air inlet 45, the latter communicating with the environment via the inlet chamber 46, via a check valve 47 that closes toward the environment. The injection of fuel into the combustion chamber 38 is effected via an injection valve 48 in the cylinder head of the combustion cylinder 38.

The motor piston 42 has a piston rod 50. This piston rod 50 plunges into an axial bore in the hydraulic cylinder 40 and forms a hydraulic piston 52, on the opposite side from the motor piston. By means of the hydraulic piston 52, the axial bore is subdivided into a cylinder chamber 54 and an annular chamber 56. The annular chamber 56 can be made to communicate with the cylinder chamber 54 via a check valve 56, which is embodied in the hydraulic piston 52 and opens toward the cylinder chamber 54. Pressure fluid from the low-pressure reservoir 28 and the low-pressure line 24 reaches the annular chamber 56 via a check valve 60, which opens toward the annular chamber 56.

A further low-pressure reservoir 61 communicates with the low-pressure line 24 shortly before the check valve 60, outside the annular chamber 56. A 2/2-way valve 62 is connected to the cylinder chamber 54 and establishes a communication with a tank T or else is closed. One work connection of a logic element 64 is also in pressure fluid communication with the cylinder chamber 54; its other work connection communicates with a high-pressure reservoir 66 and the high-pressure line 20. A 3/2-way valve 68 is operatively connected to a control connection of the logic element 64 and controls a communication with either the tank T or the high-pressure line 20.

In operation of the free-piston engine 4, combustion energy that is generated in the combustion chamber 43 is converted via the axial motion of the motor piston 42, the piston rod 50, and the hydraulic piston 52 into hydraulic energy: Pressure fluid, pumped from the low-pressure reservoir 28 via the pressure line 24 into the cylinder chamber 54, is compressed in that chamber and then reaches the high-pressure reservoir 27 via the high-pressure line 20. The free-piston engine 4 is controlled via a control unit 70. The free-piston engine 4 can be controlled and operated quite variably. Moreover, the free-piston engine 4 can be quite compact in its construction and is distinguished by great simplicity and a high power-to-weight ratio. For additional information on the mode of operation and on the construction of the free-piston engine 4, German Patent Disclosure DE 100 26 728 A1 may be referred to.

The hydraulic machine 6 can be operated as a hydraulic motor or a hydraulic pump. If the hydraulic machine 6 is operated as a hydraulic motor 6, then it is supplied with pressure fluid and driven via the high-pressure reservoir 27, the high-pressure line 20, and the high-pressure connection 18, and the pressure fluid is then carried onward via the low-pressure connection 22 into the low-pressure reservoir 28. With the clutch 16 engaged, the hydraulic motor 6 drives the drive shaft 8 via the transmission 14, and the drive shaft in turn drives the wheels 34 via the differential gear 30 and the wheel drive 32.

The hydraulic machine 6 is used as a hydraulic pump 6 when the wheels 34, for instance in braking of the vehicle, drive the drive shaft 8 via the wheel drive 32 and the differential gear 30, and the drive shaft in turn drives the hydraulic pump 6 via the transmission 14 and the engaged clutch 16. In this situation, the ICE 2 is disengaged. The hydraulic pump 6 then pumps pressure fluid from the low-pressure reservoir 28 to the high-pressure reservoir 27 via the pressure lines 20, 24, so that the high-pressure reservoir is filled. Thus with the hydraulic pump 6, the braking energy generated in braking is converted into hydraulic energy and is stored in the high-pressure reservoir 27.

With the clutch 12 engaged, the ICE 2 drives the drive shaft 8 via the transmission 10, and the drive shaft then transmits torque to the wheels 34.

The hybrid drive 1 can be used quite variously. At high speeds and with a high power demand by the vehicle, it is driven via the ICE 2, which at full load has very high efficiency. If the vehicle is to be operated with maximum power of the hybrid drive 1, then the hydraulic motor 6 is added as well, and the vehicle is simultaneously driven by two motors 2, 6 in the “boosting” mode. The hydraulic motor 6 is supplied with energy via the high-pressure reservoir 27, which in turn is filled by the free-piston engine 4.

In stop-and-go traffic, that is, a brief acceleration phase followed by a deceleration phase, for instance as with garbage trucks or cars in city traffic, the vehicle is driven with the hydraulic serial hybrid drive, comprising the hydraulic machine 6 and the free-piston engine 4. The vehicle is accelerated by the hydraulic machine 6 in the form of the hydraulic motor 6, and in deceleration and braking, the hydraulic machine 6 is used as a hydraulic pump 6.

By the recovery of the braking energy of the vehicle, the additional energy demand for the hydraulic motor 6 is limited solely to compensating for the losses that occur for instance from driving resistance (air resistance, rolling resistance) and conversion losses in the drive train. This slight energy demand is then covered by the free-piston engine 4, because it fills the high-pressure reservoir 27 in the reservoir filling mode. In this range of use of the vehicle, the free-piston engine 4 is highly efficient, and as a result fuel consumption and CO₂ emissions are reduced significantly.

The ICE 2 and the hydraulic machine 6, as drive assemblies, can in all power ranges be connected to and disconnected from the drive train 8 independently of one another and arbitrarily, thus making an extreme degree of flexibility of the hybrid drive 1 possible, and the hybrid drive can be operated with the best possible efficiency and optimally adapted power.

The invention is not limited to the exemplary embodiment described above. It is conceivable to operate the serial hybrid drive electrically instead of hydraulically. In that case, the high-pressure reservoir 27 would be embodied as a battery, and the hydraulic drive 6 would be embodied as an electric drive that can be used as a generator and motor.

A hybrid drive is disclosed, having at least two primary assemblies and a hydraulic or electric machine; one primary assembly and the hydraulic or electric machine are operatively connected to a drive train, and the hydraulic or electric machine, with this primary assembly, forms a parallel hybrid drive, and with the other primary assembly, it forms a serial hybrid drive.

It will be understood that each of the elements described above, or two or more together, may also find a useful application in other types of constructions differing from the types described above.

While the invention has been illustrated and described as embodied in a hybrid drive, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A hybrid drive, comprising a drive shaft; at least two primary assemblies; a machine selected from the group consisting of a hydraulic machine and an electric machine, said machine and one of said primary assemblies being operatively connected to said drive shaft, said machine together with said one primary assembly forming a serial hybrid drive and with the other of said primary assemblies forming a parallel hybrid drive.

2. A hybrid drive as defined in claim 1, wherein said primary assemblies have a different size relative to power of said primary assemblies.

3. A hybrid drive as defined in claim 2, wherein a larger one of said primary assembles is operatively connected to said drive shaft and is an internal combustion engine.

4. A hybrid drive as defined in claim 2, wherein a smaller one of said primary assemblies forms a serial hybrid drive with said machine and is a free-piston engine.

5. A hybrid drive as defined in claim 4, further comprising a low-pressure reservoir and a high-pressure reservoir, said free-piston engine being connected on a low-pressure side to said low-pressure reservoir via a low-pressure line and on a high-pressure side to said high-pressure reservoir via a high-pressure line.

6. A hybrid drive as defined in claim 1, wherein said hydraulic machine is connected to a high-pressure line and a low-pressure line.

7. A hybrid drive as defined in claim 1, further comprising a clutch and a transmission, said hydraulic machine being operatively connected to said drive shaft via said clutch and said transmission.

8. A hybrid drive as defined in claim 1, wherein said hydraulic machine is configured as a machine selected from the group consisting of a hydraulic pump and a hydraulic motor.

9. A hybrid drive as defined in claim 3, further comprising a clutch and a transmission, said internal combustion engine being operatively connected to said drive shaft via said clutch and said transmission.

10. A hybrid drive as defined in claim 1, further comprising a differential gear and a wheel drive located on it, said drive shaft being operatively connected to said differential gear and to said wheel drive.

11. A hybrid drive as defined in claim 1, wherein one of said primary assemblies is formed as an assembly selected from the group consisting of an internal combustion engine, a hydraulic motor, and both and drives said drive shaft.

12. A hybrid drive as defined in claim 10, further comprising a differential gear, and a wheel drive, one of said assemblies being a hydraulic pump, said wheel drive driving said hydraulic pump via said differential gear and said drive shaft.
